(19) United States
(12) Patent Application Publication
(10) Pub. No.: US 2015/0218884 A1
(43) Pub. Date: Aug. 6, 2015

(54) STABILISING LEG ASSEMBLY FOR A LADDER

(71) Applicant: Christopher John Kempthorne, Hamilton (NZ)

(72) Inventor: Christopher John Kempthorne, Hamilton (NZ)

(21) Appl. No.: 14/606,114

(22) Filed: Jan. 27, 2015

(30) Foreign Application Priority Data
Jan. 31, 2014 (NZ) 620569

(51) Int. Cl. E06C 1/20

(52) U.S. Cl. CPC E06C 1/20

(57) ABSTRACT

A stabilising leg assembly (1) for a ladder, having a bracket (9) for attachment to a ladder stile (5), and a support leg (13) pivotally attached to the bracket (9) about a first axis (LA). The bracket is attached to the stile (5) such that the bracket is pivotable relative to the stile about a second axis (BA) that is substantially perpendicular to the first axis. A single support strut (15) has a first end attached or attachable to the support leg, and a second end for attachment to a stile. The strut is movable relative to the support leg.

### FIELD OF THE INVENTION

This invention relates to a stabilising leg assembly for attachment to a ladder, and a ladder having a stabilising leg assembly.

### BACKGROUND

Falls from ladders are one of the greatest causes of serious injury in the home and in industrial and commercial workplaces.

Ladders are used on a variety of surfaces. In many instances the ground or surface on which a ladder is used is uneven, sloped or stepped. This makes the ladder susceptible to move, especially when a person stands on the upper ladder rungs. Ladder movement can also occur if the ground the ladder is rests on is soft or less stable than expected. Ladder falls may be caused by the base of the ladder slipping, the top of the ladder tipping sideways, the ladder flipping rearwards, or loss of contact between the top of a ladder and a building or other structure against which it is resting.

Various forms of outriggers have been developed to support and stabilize ladders. However, these have generally have been cumbersome, difficult to adjust and too costly for general use. In addition, many cannot be retro-fitted to existing ladders while complying with national safety standards. As a result, no such devices have been widely adopted.

In this specification where reference has been made to patent specifications, other external documents, or other sources of information, this is generally for the purpose of providing a context for discussing the features of the invention. Unless specifically stated otherwise, reference to such external documents or such sources of information is not to be construed as an admission that such documents or such sources of information, in any jurisdiction, are prior art or form part of the common general knowledge in the art.

It is an object of at least preferred embodiments of the present invention to address at least one of the above mentioned disadvantages and/or to at least provide the public with a useful alternative.

### SUMMARY OF THE INVENTION

A first aspect of the present invention provides a stabilising leg assembly for a ladder. The assembly comprises a bracket for attachment to a ladder stile; a support leg pivotally attached to the bracket about a first axis; attachment means for attaching the bracket to the stile such that the bracket is pivotable relative to the stile about a second axis that is substantially perpendicular to the first axis; and a single support strut having a first end attached or attachable to the support leg, and a second end for attachment to a stile. The strut is movable about its first end and relative to the support leg.

In an embodiment, the second axis is configured to extend in a transverse direction relative to the ladder and substantially perpendicular to the ladder stile when the bracket is attached to the stile. The second axis may be substantially horizontal when the ladder is in an in-use configuration.

In an embodiment, the first axis is substantially horizontal when the ladder is in an in-use configuration.

In an embodiment, the length of the support leg is adjustable. For example,

the support leg may be adjustable telescopically using a pin and aperture arrangement or a cam locking arrangement.

In such an embodiment, the support leg may comprise a movable leg segment having a plurality of apertures. The pin and aperture arrangement may comprise a pin that is engagable with the apertures, and an elastic member operatively attaching the pin to the support leg, the elastic member bring configured to be tensioned when the pin is engaged with one of the apertures.

In an embodiment, the support leg comprises a foot that is adjustable to adjust the length of the support leg. Alternatively the foot may be fixed to the lower end of the support leg. In an embodiment, the support leg comprises a rubber foot.

In an embodiment, the strut is pivotable relative to the support leg about its first end. The strut may be attached to the support leg by way of a U-shaped member. The second end of the strut may comprise a hook with an enlarged end portion.

The length of the strut may be fixed or it may be adjustable.

The assembly is preferably configured for retrofitting to an existing step ladder, A-frame ladder, or extension ladder. Alternatively, the assembly may be factory fitted to a ladder.

The bracket and the support strut may be configured to be attached to the same ladder stile or, in some ladders, may be configured to be attached to different ladder stiles. For example, in a non-extending A-frame ladder or a step ladder, the bracket may be attached to a front ladder stile and the second end of the support strut may be attached to the corresponding rear ladder stile.

The attachment means may comprise an aperture in the bracket configured to receive a connecting member such as a bolt for pivotally attaching the bracket to the stile. Alternatively the attachment means may comprise a clamp for clamping to the ladder stile, with the bracket pivotally attached to the clamp about the second axis.

A second aspect of the present invention provides a ladder comprising left and right ladder stiles and a plurality of rungs extending between the stiles, and a stabilising leg assembly as described above in relation to the first aspect, with the stabilising leg assembly bracket attached at or towards the top of one of the stiles.

In an embodiment, the ladder comprises a left stabilising leg assembly with the left stabilising leg assembly bracket attached at or towards the top of the left stile, and a right stabilising leg assembly with the right stabilising leg assembly bracket attached at or towards the top of the right stile. Preferably each stile has a strut engagement feature for engaging the second end of the respective strut. The strut engagement feature may be a D-shaped member, U-shaped member, or an aperture, for example.

A third aspect of the invention provides a ladder comprising at least one stabilising leg assembly. The leg assembly comprises a bracket pivotally attached at or near the top of a ladder stile about a first axis; a support leg pivotally attached to the bracket about a second axis that is substantially perpendicular to the first axis; and a single support strut having a first end movably attached or attachable to the support leg, and a second end that is movably attached or attachable to the respective ladder stile.

In an embodiment, the first axis is substantially perpendicular to the respective ladder stile. The first axis is preferably substantially horizontal.

The length of the or each support leg is preferably adjustable, for example telescopically by way of a pin and aperture arrangement.

In one such embodiment the support leg comprises a movable leg segment having a plurality of apertures, and the pin and aperture arrangement comprises a pin that is engagable with the apertures, and an elastic member operatively attached to the support leg and to the pin. The elastic member is configured to be tensioned when the pin is engaged with one of the apertures.

The or each strut may be attached to the respective support leg by way of a U-shaped member such that the strut member can pivot about the first end relative to the respective support leg, the first end being movable along at least a portion of the U-shaped member.

The second end of the or each strut may comprise a hook having an enlarged portion and the or each respective stile has a D-shaped member, U-shaped member, or an aperture for receiving the second end of the respective strut.

The length of the or each strut may be fixed. Alternatively the length of the or each strut may be adjustable.

In an embodiment, the or each bracket is pivotally attached to the respective stile by way of a bolt and aperture arrangement.

Preferably the or each bracket and the second end of the or each strut are detachable from their respective ladder stile.

The ladder may be in the form of an A-frame ladder, a step ladder, or an extension ladder.

The term ‘comprising’ as used in this specification and claims means ‘consisting at least in part of’. When interpreting statements in this specification and claims which include the term ‘comprising’, other features besides the features prefaced by this term in each statement can also be present. Related terms such as ‘comprise’ and ‘comprised’ are to be interpreted in a similar manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting. Where specific integers are mentioned herein which have known equivalents in the art to which this invention relates, such known equivalents are deemed to be incorporated herein as if individually set forth.

As used herein the term ‘(s)’ following a noun means the plural and/or singular form of that noun.

As used herein the term ‘and/or’ means ‘and’ or ‘or’, or where the context allows both.

The invention consists in the foregoing and also envisages constructions of which the following gives examples only.

### BRIEF DESCRIPTION OF THE DRAWINGS

The present invention will now be described by way of example only and with reference to the accompanying drawings in which:

FIG. 1 is a front view of a ladder having a preferred form stabilising leg assembly attached to each of the left and right ladder stiles, with the leg assembly support legs retracted and pivoted inwards to a storage position;

FIG. 2 is a view corresponding to FIG. 1 but with the leg assembly support legs extended and pivoted outwards to an in-use position for stabilising the ladder;

FIG. 3 is a right side view corresponding to FIG. 2;

FIG. 4 is an enlarged view of one of the leg assembly brackets attached to a stile;

FIG. 5 is a front left partial perspective view showing the left leg assembly support strut attached to the left ladder stile;

FIG. 6 is an enlarged front view of the configuration of FIG. 1, showing the lock pin locking the left support leg in the retracted position and the elastic member connecting the pin to the support leg tensioned;

FIG. 7 is an enlarged perspective view showing the securing strap holding one of the strut members parallel to the support leg; and

FIG. 8 is a front perspective view of components of a clamp for attaching an alternative embodiment stabilising leg assembly to an existing ladder.

### DETAILED DESCRIPTION OF A PREFERRED EMBODIMENT

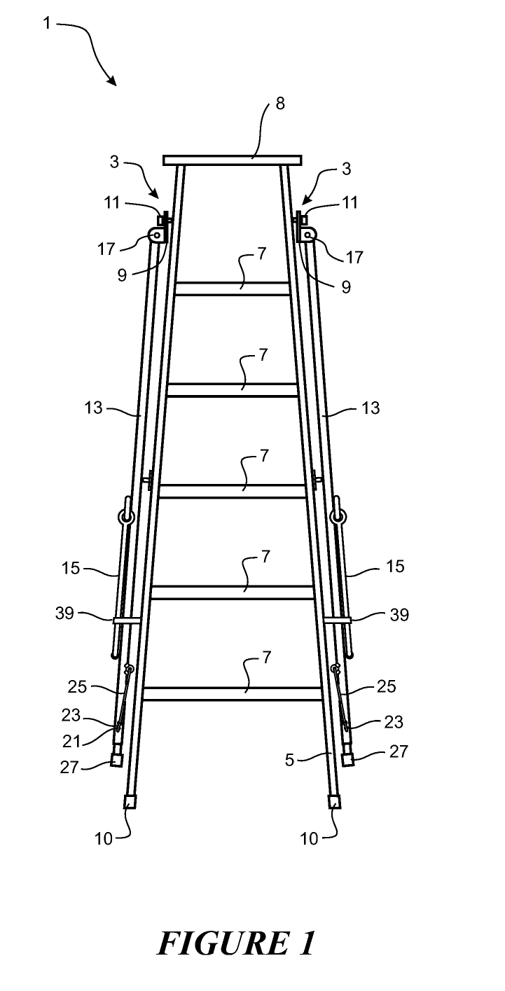

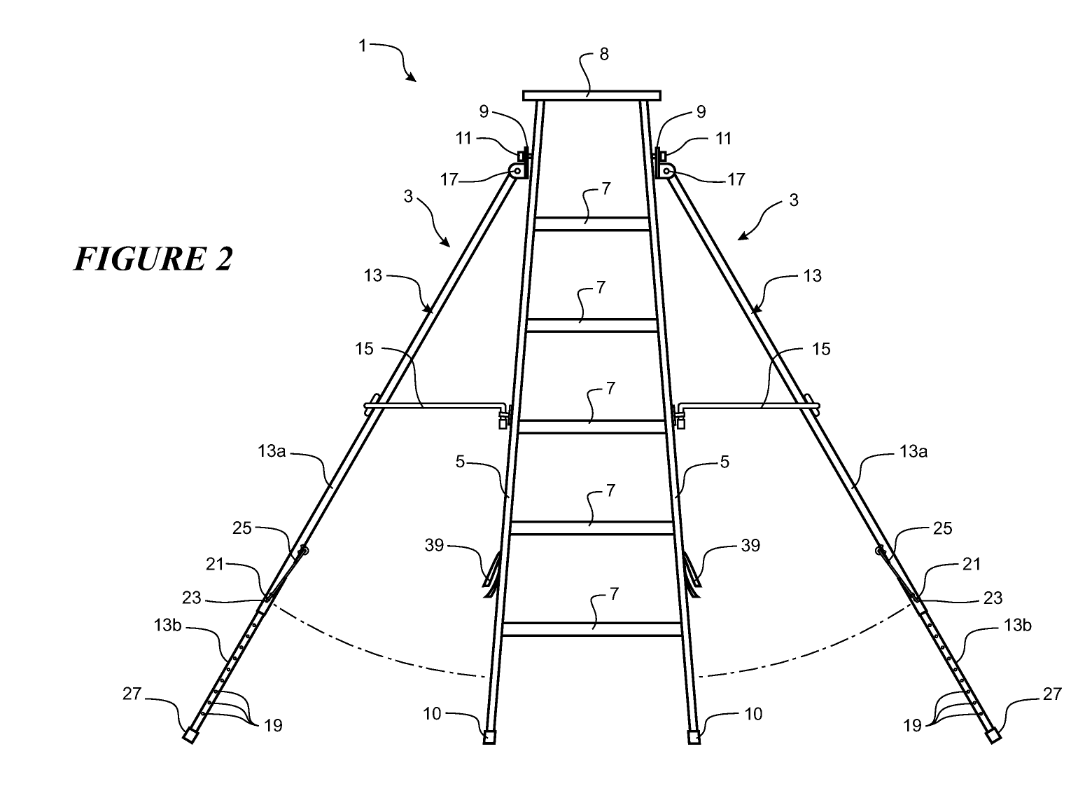

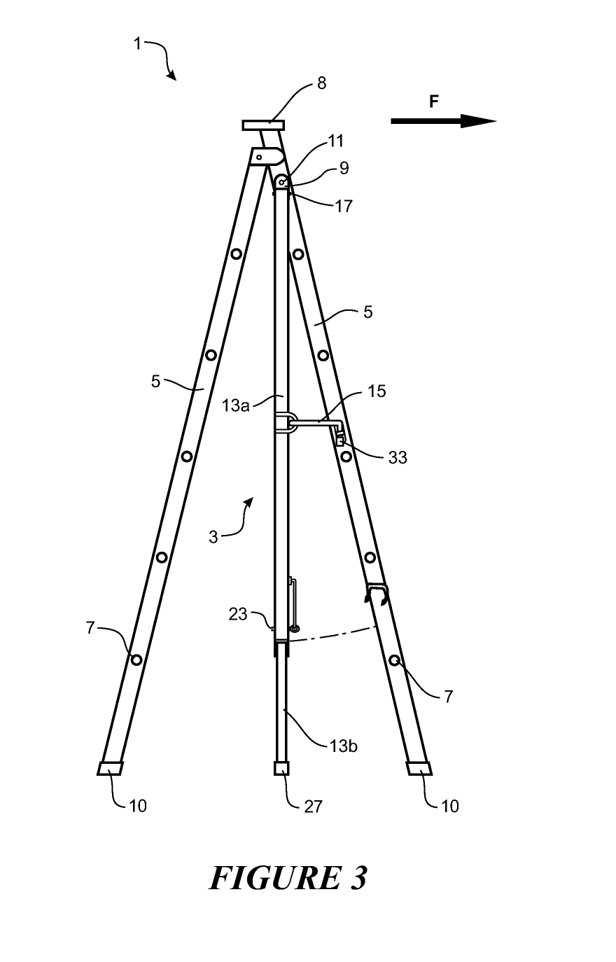

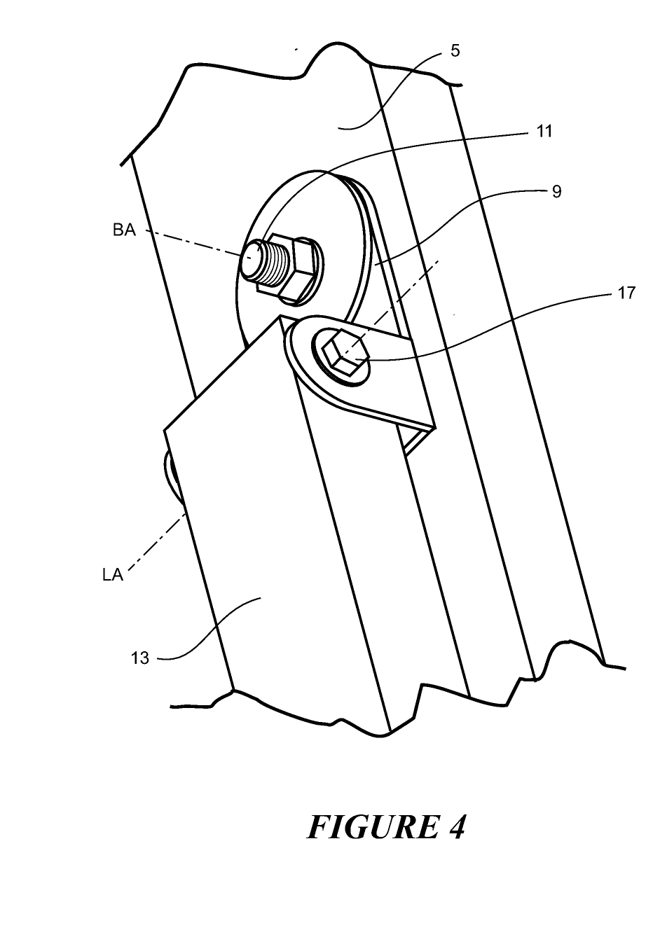

FIGS. 1 to 7 illustrate a ladder 1 fitted with left and right stabilising leg assemblies 3 in accordance with a preferred embodiment of the present invention. The ladder 1 comprises left and right stiles 5, with rungs 7 extending between the stiles 5, and a top platform 8. Each stabilising leg assembly 3 is attached to the respective stile at or towards the top of the stile 5. In the embodiment shown, each support leg assembly 3 is attached to the respective stile 5 between the top rung 7 and the top platform 9. An arrow marked ‘F’ is shown in FIG. 3 to indicate a forward direction of the ladder 1. Accordingly the terms forward, rearward, left side, and right side (or similar) should be construed with reference to the forward direction F of the ladder 1.

Each stabilising leg assembly 3 comprises a bracket 9 for attaching to a ladder stile 5, a support leg 13 pivotally attached to the bracket 9, a support strut 15 attached to the support leg 13, and attachment means 11 for pivotally attaching the bracket 9 to the stile. In the embodiment shown, the attachment means 11 comprises a bolt or other connecting member extending through the bracket 9 and the respective stile 5, perpendicular to the stile 5. Each bracket 9 is attached to the outer face of the respective ladder stile 5, towards the top of the stile 5 and is pivotable relative to the stile 5 about the longitudinal axis BA of the bolt. The longitudinal axis BA extends transversely outwardly from the respective stile 5.

Each stabilising leg assembly bracket 9 is preferably attached to the respective stile 5 as high as possible on the stile 5 for maximum stability. For example, the bracket 9 is preferably attached to the stile 5 in the top third of the stile, and more preferably above the top ladder rung, for example between the top rung 7 and the ladder platform 9.

The support leg 13 is pivotally attached to the bracket 9 about a pin or bolt 17 about a second axis LA that is substantially perpendicular to the bracket pivot axis BA. Each support leg 13 thereby has two rotational degrees of freedom relative to the respective ladder stile 5. Each support leg 13 can rotate backwards and forwards parallel to the sides of the stiles by way of the bracket 9 pivoting about the attachment bolt 11. In addition, each support leg 13 rotate laterally towards and away from the sides of the stiles by pivoting about the leg pivot pin 17.

Each support leg 13 comprises an upper portion 13a and a lower portion 13b. The lower portion 13b is slidable within the upper portion 13a to telescopically adjust the length of the support leg 13. In the embodiment shown, the upper and lower portions 13a, 13b comprise square box section, but alternatively may comprise other shape hollow members or channel section. As an alternative, the lower portion 13b may be solid in cross section, or the lower portion 13b may receive and slide over the upper portion 13a, for example.

The upper and lower leg portions 13a, 13b preferably comprise aluminum, but may comprise other materials such as other metals, fibreglass, or composites, for example.

In the embodiment shown, the inner lower leg portion 13b is approximately half the length of the upper outer leg portion 13a. The lower leg portion 13b is movable between a retracted position where substantially all of the lower portion 13b is within the upper portion 13a, and an extended position where about half of the length of the lower portion 13b is below the upper portion 13a and about half of the length of the lower portion 13b is within the upper portion 13a. However, the upper and lower leg portions 13a, 13b may be of other relative lengths and/or be extendable and retractable through a different range of the length of the lower portion 13b.

The lower leg portion 13b contains a series of apertures 19 for adjusting the length of the support leg 13. The upper leg portion 13a comprises a corresponding aperture 21 toward the lower end of the upper leg portion 13a that aligns with the apertures 19 in the lower portion as the support leg 13 is extended and retracted. The apertures 19 are preferably evenly spaced. Alternatively, the upper leg portion 13a may contain a series of apertures and the lower leg portion 13b may comprise a corresponding aperture 21 that aligns with the apertures in the upper portion as the support leg 13 is extended and retracted.

Rather than a pin and aperture arrangement, the support leg 13 may comprise an alternative mechanism for adjusting the length of the leg 13. Suitable mechanisms would be apparent to a person skilled in the art. As one example, the upper and lower leg portions 13a, 13b may comprise telescopic cylindrical members with a cam mechanism that enables the leg portions 13a, 13b to be fixed in different relative positions by twisting the lower leg portion 13b relative to the upper leg portion 13a.

A pin or eyebolt 23 is positioned through the aperture 21 in the upper leg portion 13a and through one of the apertures 19 in the lower leg portion 13b to lock the lower leg portion 13b relative to the upper leg portion 13a. The support leg 13 is adjustable to a plurality of lengths corresponding to the plurality of apertures 19. When the pin 23 extends through the upper most aperture 19 on the lower leg portion 13b, the leg 13 is locked in its most extended position. When the pin 23 extends through the lower most aperture 19 on the lower leg portion 13b, the leg 13 is locked in its most retracted position.

If the lower leg portion 13b is a hollow member, it may be filled with solid material before drilling the locking apertures 19 to provide improved alignment of the locking apertures 19, 21.

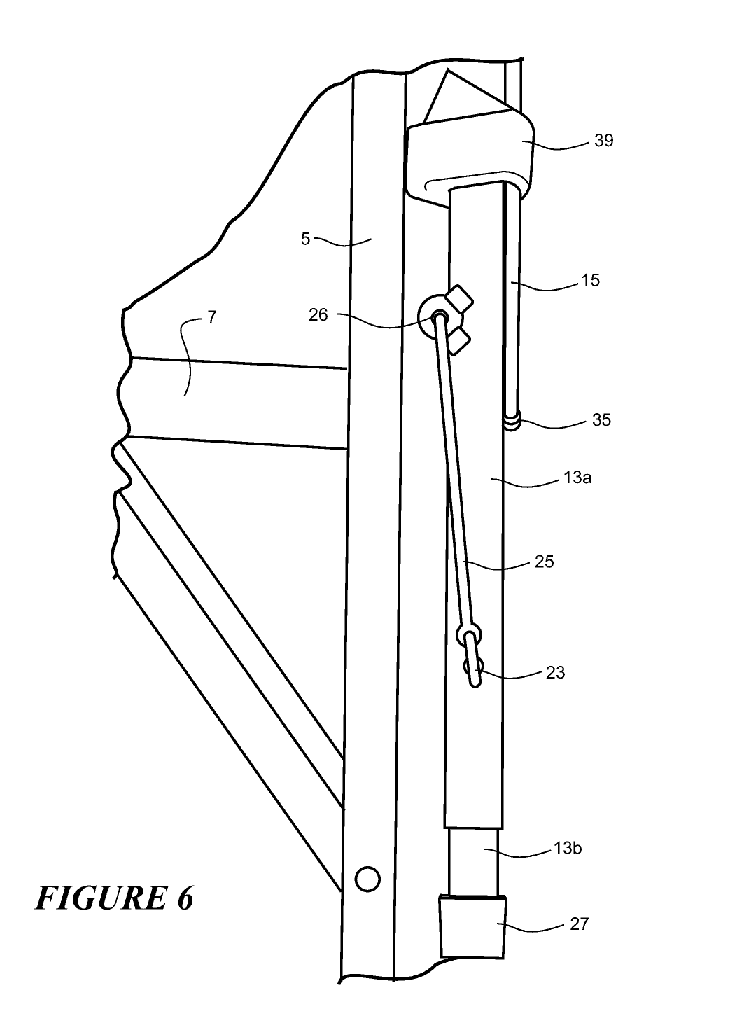

An elastic member 25 is attached to the lock pin or eyebolt 23 and to the upper leg portion 13a as shown in FIG. 6. Alternatively, the elastic member 25 may be indirectly attached to the support leg and/or to the lock pin or eyebolt. For example, one end of a chain or other flexible member 25 may be attached to the upper leg portion 13a and the elastic member 25 may be connected to the chain and to the lock pin or eye bolt 23.

The elastic member 25 has an unstretched length less than the dimension between the aperture 21 in the upper leg portion 13a and the connection 26 of the elastic member 25 with the upper leg portion 13a such that the elastic member 25 is in tension when the lock pin 23 is positioned in the apertures 19, 21. When the lock pin 23 is withdrawn slightly from the locking apertures 19, 21, the tension on the elastic member 25 increases, acting to resist removal of the lock pin 23 from its locking position. The elastic member also prevents loss of the pin when it has been removed from the support leg apertures.

The elastic member 25 is preferably attached to the upper leg portion 13a towards the lower end of the upper leg portion 13a. The elastic member 25 may be attached to the upper leg portion 13a by any suitable means, for example by a metal cable tie or by a high bond strength glue. In the embodiment shown, the elastic member 25 is tied to a lug 26 welded to the upper leg portion 13a. The elastic member preferably comprises an elastomeric material.

Each support leg 13 comprises a foot 27 that contacts the ground when the support legs 13 are deployed. In the embodiment shown, each support foot 27 comprise a rubber foot piece securely fitted over the lower end of the respective lower leg portion 13b. The rubber provides increased friction between the foot and the ground to help prevent slipping of the support leg 13. Alternatively, the feet 27 may comprise plastic or another suitable material. The foot 27 may be adjustable relative to the respective lower leg portion 13b to provide fine adjustment of the support leg 13 length, for example by way of a threaded connection between the foot and the lower leg portion 13b.

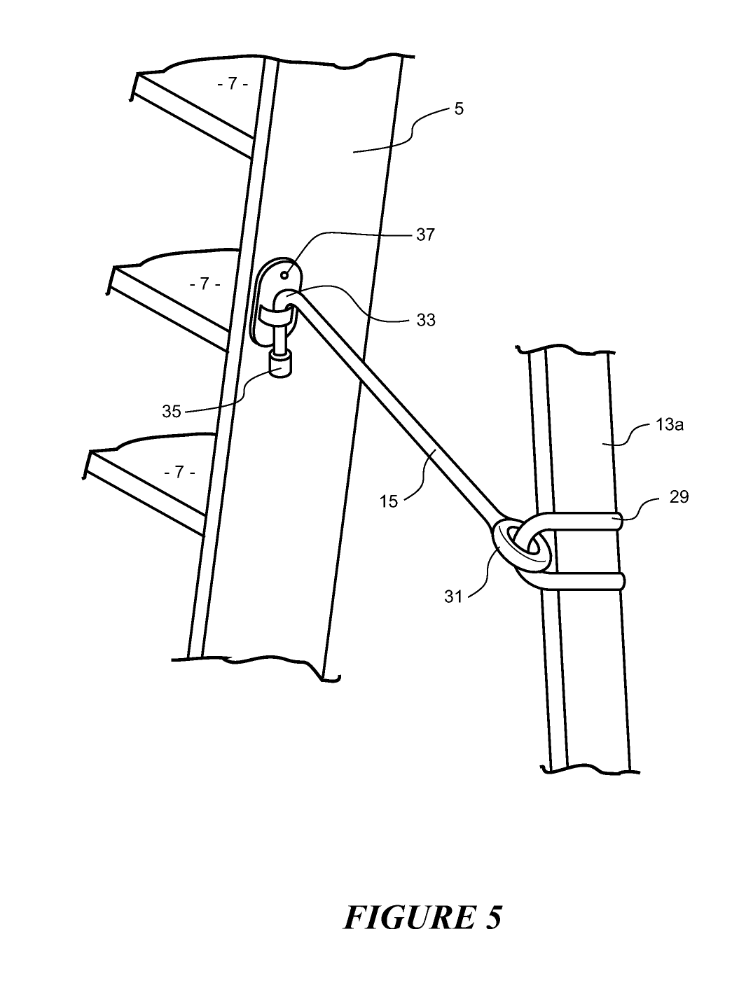

The support strut 15 has a first end 31 attached to the upper leg portion 13a, and a second end 33 for attachment to the respective stile 5. The strut 15 is attached to the upper leg portion 13a such that it is movable relative to the support leg 13 about the first end of the strut. In the embodiment shown, and as illustrated in FIG. 5, the support strut 15 is attached permanently to the upper leg portion 13a by a U-shaped attachment 29 welded to the upper leg portion. An eye-loop 31 on the end of the support strut 15 is received by the U-shaped attachment 29.

The second end of the support strut 15 comprises a right-angled hook 33. The hook 33 is received by a D-loop attachment bracket 37 that is permanently bolted to a front portion of the lateral side of each stile 5. The end of the hook 33 comprises a small plastic cap 35 to enlarge the end of the hook. The width of the plastic cap 35 at its widest part is slightly wider than the aperture in the D-loop for receiving the hook 33 such that a downward force must be applied to the strut 15 to press the cap 35 through the aperture and engage the hook 33. This prevents accidental upward slippage of the hook 33 from the D-loop 37 when the support legs 13 are deployed.

In an alternative embodiment, the support strut 15 may be permanently movably attached to the stile 5 and engagable with a feature such as a D-loop on the support leg 13. As a further alternative, the support strut 15 may be foldable and its ends permanently movably attached to the stile 5 and to the support leg 13 respectively. For example, the strut may be foldable about a hinge at or near a mid-point of the strut. In such an embodiment, the strut would be locked in a straight configuration when the stabilising leg assembly was deployed, and collapsed to a folded position to allow the support leg 13 to be dropped parallel to the stile for storage.

The length of the support strut 15 is preferably fixed. Because only a single strut is employed for each support leg 13, a fixed length strut 15 is sufficient to provide a wide range of possible positions of the support leg 13. However, alternatively the length of the support strut may be adjustable. An adjustable support strut would allow the distance between the deployed legs and the ladder strut to be altered to enable use of the stabilising leg assemblies in a wider range of spaces and ground surfaces. A fixed length support strut 15 provides the advantage of a simpler, cheaper assembly.

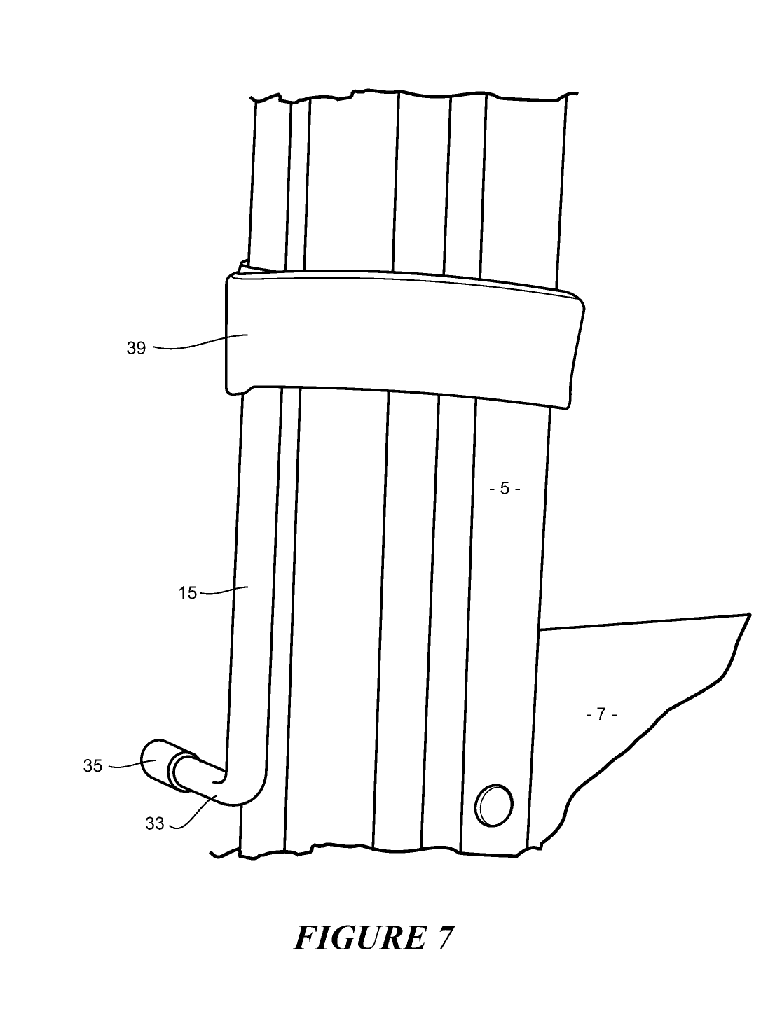

As shown in FIG. 7, the ladder 1 may comprise straps 39 for holding the stabiliser leg assemblies 3 against the stiles 5 when they are not deployed. The ends of the straps 39 may be secured to each other using a hook and loop type fastener, or they may tie together or be otherwise secured.

To use the ladder stabilising leg assemblies 3 to stabilise the ladder, the ladder is placed in the desired position with the stabilising leg assemblies retracted and held against the stiles 5 in the stored position shown in FIG. 1. The straps 39 are released to allow the stabilising leg assemblies 3 to move relative to the stiles 5. For each leg assembly 3, the support leg 13 is pivoted outwards away from the stiles about the second axis LA, and the hook end 33 of the support strut 15 is engaged with the respective D-loop bracket 37 on the respective ladder stile 5.

The locking pin 23 is then removed from the leg apertures 19, 21 to unlock the lower support leg portion 13b from its retracted position, enabling it to be slid relative to the upper leg portion 13a to adjust the length of the support leg 13. When the desired leg length is reached, the locking pin 23 is inserted through the upper portion locking aperture 21 and the respective lower leg portion locking aperture 19 to lock the leg 13 in its desired length.

From this position, with the support legs 13 extending outwards in the lateral plane of the ladder as shown in FIG. 3, the extended legs 13 are movable in an arc defined by the support strut 15, about the hook end 33 of the support strut 15 and self adjust into position. The use of a single strut only for each support leg provides this adjustability through an arc.

If necessary, the extended legs 13 may then be manually pivoted forwards or rearwards until the support leg feet 27 engage the ground surface and to accommodate any variation in ground level. For example, if the ground is higher towards the rear of the ladder, the extended legs 13 may be pushed rearwards. Conversely, if the ground is higher towards the front of the ladder, the extended legs 13 may be pulled forwards. As the legs are pushed forwards or rearwards, the stabilising leg assembly bracket 9 pivots about the bracket pivot axis BA and the support leg 13 simultaneously pivots about the second axis LA. The position shown in FIG. 3, with the support legs 13 extending in the lateral plane of the ladder to provide maximum stabilising support to the ladder 1.

The connection of the strut 15 through the D-loop allows the strut 15 to freely pivot forwards or backwards about the hook connection 33 as the support leg 13 moves. The pivoting of the support strut 15 allows the respective support leg 13 to be accurately and easily adjusted to make stable contact with the ground. The rubber feet 27 have maximal contact with the ground with a corner edge to provide maximal pressure against the ground to transfer downwards force through a small area.

Base slip of ladder is reduced as there are four ladder feet on the ground, and the design of stabiliser will mean increased ground pressure will occur in the stabiliser feet 27 if the main ladder feet 10 were to attempt to slip forwards. The upper mounting of the stabiliser is preferably as high as possible to provide maximum stability.

The U-shaped attachments make movement possible at both ends of each strut to enable each support strut 15 to be moved through a wide range of movement relative to the respective support leg 13. The strut attachments self locks to rigidly anchor the support leg 13 to the stile 5 when the support leg 13 is deployed and the second end of the strut 15 is attached to the respective stile 5.

When the support legs 13 are deployed in the lateral plane as shown in FIG. 3, they support the ladder 1 by directly reacting any lateral force vector caused by side slippage of the ladder. In addition, if the main ladder feet 10 start to slip away (one main cause of ladder falls) this will cause relative movement of the support legs 13, and increase downward pressure on the ground through the support legs 13 and stabilising leg assembly feet 27, minimising or preventing the base of the ladder from slipping.

The stabilising leg assemblies may be retracted and pivoted inwards for storage when they are no longer required. To retract the support legs, the locking pin 23 is removed from the leg apertures 19, 21 to unlock the lower support leg portion 13b and the lower leg portion 13b is retracted relative to the upper leg portion 13a. The locking pin 23 is inserted again through the upper portion locking aperture 21 and the lowest lower leg portion locking aperture 19 to lock the leg 13 in the retracted position.

To pivot the stabilising leg assemblies inwards, the hook end 33 of each strut 15 is removed from the D-loop bracket 37. The struts 15 may then pivot relative to the U-shaped attachment on the respective support leg 13 and be moved so they are parallel to the respective support leg 13. Each strut 15 can then be strapped with the respective support leg 13 as shown in FIG. 7, in the storage position against the side of the stile 5 by the straps 39.

The stabilising leg assemblies 3 may be retro-fitted to most existing metal ladders including A-frame ladders, step ladders, and extension ladders, preferably having a minimum stile depth of 65 mm. Alternatively, the stabiliser leg assemblies could be factory fitted to the ladder at the time of manufacture. In the case of fitting to an extension ladder, the stabilising leg assembly brackets 9 are fitted at or towards and upper end of the lowest stiles. A ladder may be fitted with a single stabilising leg assembly 3 but is preferably fitted with a pair of stabilising leg assemblies 3.

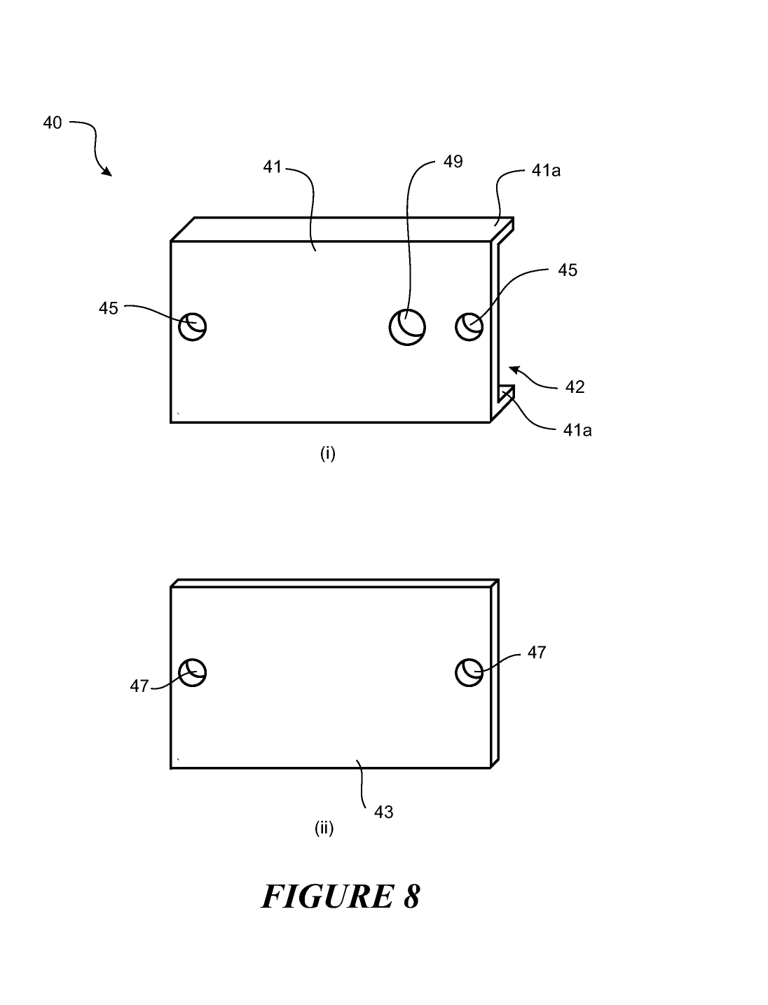

The stabilising leg assembly 3 shown in FIGS. 1 to 7 may be retrofitted to an existing ladder by drilling a hole towards the top of one of the ladder stiles and pivotally bolting the bracket 9 to the stile. Alternatively, the stabilising leg assembly 3 may be otherwise attached to the stile, particularly if it is not desirable to drill a hole in the stile 5. FIG. 8 shows an exemplary clamp 40 for clamping the stabilising leg assembly 3 to a stile 5.

The clamp 40 comprises a lateral clamping member 41 and a medial clamping member 43. Each clamping member 41 comprises at least two bolt apertures 45, 47 for bolting the two clamping members 41, 43 together. The distance between the two bolt apertures 45, 47 on each clamping member 41, 43 is greater than the depth of the stile 5.

To attach the clamp 40 to the stile 5, the medial clamping member 43 is placed on the medial face of the stile 5 at or towards the top of the stile; with one of the bolt apertures 45 positioned forward of the stile 5 and the other aperture 45 rear of the stile. The lateral clamping member 41 is placed against the opposite, lateral, face of the stile 5 with the bolt apertures 47 aligned with those 45 on the medial clamping member 43.

Two bolts are placed in respective bolt apertures and tightened to secure the clamp 40 to the stile 5. The apertures on one of the clamping members 41, 43 may be threaded, or the bolts may be tightened using a nut. Friction between the clamping members 41, 43 and the respective stile face prevents the clamp 40 moving relative to the stile 5.

Preferably the clamp 40 is positioned so that the top edge of the medial clamping bracket 43 abuts a rung 7 or the top platform of the ladder. This prevents the clamp 40 sliding upwards in response to an increased upwards force applied to the clamp 40, for example when the stabilising leg assembly 3 is supporting sideways tilting of the ladder.

The lateral clamping member 41 further comprises an aperture 49 for pivotally attaching the stabilising leg assembly bracket 9 to the clamp 40. The stabilising leg assembly 3 is attached to the clamp 40 by pivotally bolting the bracket 9 to the lateral clamping member 41 via the aperture 49. The lateral clamping member 41 has side walls 41a defining a channel 42. The channel 42 provides clearance for the bolt head or nut on the bolt attaching the bracket 9 to the clamp 40.

The clamp 40 may comprise aluminum, steel, or another suitable rigid material.

Preferred embodiments of the invention have been described by way of example only and modifications may be made thereto without departing from the scope of the invention.

For example, the length of the support legs 13 can be designed for differing ladder heights and different types of ladders. For example, longer extension ladders will require longer support legs of heavier construction than a smaller A-frame ladder. Each different stabilising leg assembly may be designed to fit a specific range of ladder lengths, and would require the stabilising leg assembly bracket 9 to be fitted to the respective stile within a given range of lengths as measured from the bottom of the ladder stile. As an example, a stabilising leg assembly with support legs adjustable between 1600 mm and 2145 mm may be suitable for ladders between 1800 mm and 2100 mm in height, but with slight variation in the height of placement of bracket 9.

What I claim is:

1. A stabilising leg assembly for a ladder, the assembly comprising:
a bracket for attachment to a ladder stile;
a support leg pivotally attached to the bracket about a first axis;
attachment means for attaching the bracket to the stile such that the bracket is pivotable relative to the stile about a second axis that is substantially perpendicular to the first axis; and
a single support strut having a first end attached or attachable to the support leg, and a second end for attachment to a stile, the strut being movable about its first end and relative to the support leg.

2. A stabilising leg assembly as claimed in claim 1, wherein the second axis is configured to extend in a transverse direction relative to the ladder and substantially perpendicular to the ladder stile when the bracket is attached to the stile.

3. A stabilising leg assembly as claimed in claim 1, wherein the second axis is substantially horizontal when the ladder is in an in-use configuration, and wherein the first axis is substantially horizontal when the ladder is in an in-use configuration.

4. A stabilising leg assembly as claimed in claim 1, wherein the length of the support leg is adjustable.

5. A stabilising leg assembly as claimed in claim 4, wherein the support leg is adjustable telescopically using a pin and aperture arrangement, wherein the support leg comprises a movable leg segment having a plurality of apertures, and the pin and aperture arrangement comprises a pin that is engagable with the apertures, and an elastic member operatively attaching the pin to the support leg, the elastic member being configured to be tensioned when the pin is engaged with one of the apertures.

6. A stabilising leg assembly as claimed in claim 4, wherein the support leg comprises a foot that is adjustable to adjust the length of the support leg.

7. A stabilising leg assembly as claimed in claim 1, wherein the strut is attached to the support leg by way of a U-shaped member such that the strut is pivotable relative to the support leg about its first end.

8. A stabilising leg assembly as claimed in claim 1, wherein the second end of the strut comprises a hook having an enlarged end portion.

9. A stabilising leg assembly as claimed in claim 1, wherein the length of the strut is fixed.

10. A stabilising leg assembly as claimed in claim 1, wherein the assembly is configured for retrofitting to an existing step ladder, A-frame ladder, or extension ladder.

11. A ladder comprising left and right ladder stiles and a plurality of rungs extending between the stiles, and a stabilising leg assembly as claimed in claim 1, the stabilising leg assembly bracket being attached at or towards the top of one of the stiles.

12. A ladder as claimed in claim 11, comprising a left stabilising leg assembly, the left stabilising leg assembly bracket being attached at or towards the top of the left stile; and a right stabilising leg assembly, the right stabilising leg assembly bracket being attached at or towards the top of the right stile.

13. A ladder as claimed in claim 11, wherein each stile has a D-shaped member, U-shaped member, or an aperture for engaging the second end of the respective strut.

14. A ladder comprising at least one stabilising leg assembly, the leg assembly comprising:
a bracket pivotally attached at or near the top of a ladder stile about a first axis;
a support leg pivotally attached to the bracket about a second axis that is substantially perpendicular to the first axis; and
a single support strut having a first end movably attached or attachable to the support leg, and a second end that is movably attached or attachable to a ladder stile.

15. A ladder as claimed in claim 14, wherein the first axis is substantially perpendicular to the respective ladder stile, and/or the first axis is substantially horizontal when the ladder is in an in-use configuration.

16. A ladder as claimed in claim 14, wherein the bracket and the support strut are attached or attachable to the same ladder stile.

17. A ladder as claimed in claim 14, wherein the length of the or each support leg is adjustable telescopically by way of a pin and aperture arrangement, wherein the support leg comprises a movable leg segment having a plurality of apertures, and the pin and aperture arrangement comprises a pin that is engagable with the apertures, and an elastic member operatively attached to the support leg and to the pin, wherein the elastic member is configured to be tensioned when the pin is engaged with one of the apertures.

18. A ladder as claimed in claim 14, wherein the or each strut is attached to the respective support leg by way of a U-shaped member such that the strut member can pivot about the first end relative to the respective support leg, the first end being movable along at least a portion of the U-shaped member.

19. A ladder as claimed in claim 14, wherein the second end of the or each strut comprises a hook having an enlarged portion and the or each respective stile has a D-shaped member, U-shaped member, or an aperture for receiving the second end of the respective strut.

20. A ladder as claimed in claim 14, wherein the length of the or each strut is fixed.
